(19) United States
(12) Patent Application Publication
(10) Pub. No.: US 2021/0382798 A1
(43) Pub. Date: Dec. 9, 2021

(54) OPTIMIZING CONFIGURATION OF CLOUD INSTANCES

(71) Applicant: ServiceNow, Inc., Santa Clara, CA (US)

(72) Inventors: Ashok Ganesan, Milpitas, CA (US); Manish Kumar Das, Amsterdam (NL); Parthasarathy Murappakkam Srinivasan, Fremont, CA (US); Sneha Banerjee, San Jose, CA (US); Samujjwal Bhandari, San Jose, CA (US); Chhavi Jain, Milpitas, CA (US); Arjun Badarinath, Fremont, CA (US); Rama Raghava Reddy Bandi, San Jose, CA (US)

(21) Appl. No.: 16/893,351

(22) Filed: Jun. 4, 2020

(51) Int. Cl. G06F 11/20; H04L 29/08; H04L 12/26; H04L 12/24

(52) U.S. Cl. CPC G06F 11/203; G06F 11/2025; H04L 67/10; G06F 2201/85; H04L 67/148; H04L 41/0654; H04L 43/0876

(57) ABSTRACT

Cloud computing utilization measurements associated with a cloud computing instance are received. Metrics based on the cloud computing utilization measurements are calculated. Based on a user configurable resource evaluation criteria, whether a different cloud computing instance among eligible cloud computing resource unit options is a better match than a current cloud computing resource unit handling the cloud computing instance is evaluated. A selected one of the eligible cloud computing resource unit options is indicated as the better match than the current cloud computing resource unit handling the cloud computing instance.

### BACKGROUND OF THE INVENTION

Cloud instances allow for the hosting of services on virtual servers running in a cloud network. The virtual servers can be accessed remotely and can be an ideal deployment platform for online and web services. The cloud instances function similar to self-hosted servers but allow for increased flexibility. For example, cloud instances covering a wide range of hardware and software configurations can be made available on demand. Different server configurations can include different operating system, memory, processor, storage, and/or network configurations, among other configurable parameters. Due to the flexible nature of cloud instances, software and services deployed to virtual servers can be scaled up and down by adding/removing cloud instances and/or transitioning to different cloud instance configurations.

### BRIEF DESCRIPTION OF THE DRAWINGS

Various embodiments of the invention are disclosed in the following detailed description and the accompanying drawings.

FIG. 1 is a block diagram illustrating an example of a network environment for running and configuring cloud instances.

FIG. 2 is a flow chart illustrating an embodiment of a process for optimizing the configuration of cloud instances.

FIG. 3 is a flow chart illustrating an embodiment of a process for configuring operating requirements of cloud instances.

FIG. 4 is a flow chart illustrating an embodiment of a process for monitoring the operation of a cloud instance.

FIG. 5 is a flow chart illustrating an embodiment of a process for identifying optimal cloud instance configurations.

FIG. 6 is a flow chart illustrating an embodiment of a process for migrating to a new cloud instance configuration.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Optimizing the configuration of cloud instances is disclosed. The availability of a wide variety of cloud instance configurations makes the virtualization of servers hosted on a cloud network an attractive solution for many deployment situations. Cloud instances are often pre-configured to cover a wide range of different use cases and needs. The cloud instance configurations themselves can include a variety of different software configurations such as different operating system, driver, and/or software package configurations as well as different hardware configurations such as CPU, disk, storage, network, and/or memory configurations. The availability of different cloud instance options allows an administrator to select a cloud instance that closely matches deployment requirements. Depending on fit, an administrator can later choose a different configuration to scale up or down the deployment. However, selecting the optimal configuration for cloud instances is technically challenging. The sheer number of different configurations and the dynamic and unpredictable workload of deployed services make the task extremely complex and difficult to optimize. Therefore, there exists a need to automate the optimization of cloud instance configurations.

In some embodiments, an administrator specifies optimal metrics for running a cloud instance. For example, an administrator specifies the ideal CPU utilization of a virtual server. The utilization can be specified as a threshold, such as an ideal CPU utilization having a threshold range of 60-80%. A CPU utilization over 80% indicates the cloud instance is over-utilized and a CPU utilization under 60% indicates the cloud instance is under-utilized. In either an over- or under-utilization scenario, a more optimal cloud instance configuration may exist. If a more optimal configuration exists, the deployment should be migrated to the new configuration. In some embodiments, the administrator also configures a lookback duration, such as a 14-day window, to specify the duration over which the cloud instance metrics are reviewed (e.g., over the last 14 days) to determine under/over utilization. In various embodiments, metrics for the cloud instance are captured over the lookback duration and analyzed compared to the specified optimal metrics. Available optimal configurations are identified and the administrator is prompted to migrate the deployment to a suggested configuration that is more optimal and automatically identified. In some embodiments, the determination of more optimal alternatives involves normalizing the cloud instance metrics to compare the viability and compatibility of the different available options.

In some embodiments, cloud computing utilization measurements associated with a cloud computing instance are received. For example, measurements associated with CPU, storage, memory, and/or network utilization, among other possible utilization metrics are captured. In some embodiments, the measurements are captured over a specified lookback duration, such as a week, 14 days, or another duration. Metrics based on the cloud computing utilization measurements are calculated. For example, metrics based on the captured measurements are calculated by normalizing the measurements to one or more standardized units. The normalized measurements allow the cloud instance utilization to be compared with different cloud instance configurations. Based on a user configurable resource evaluation criteria, whether a different cloud computing resource unit among eligible cloud computing resource unit options is a better match than a current cloud computing resource unit handling the cloud computing instance is evaluated. For example, an administrator can specify a user configurable resource evaluation criteria such as an ideal CPU utilization threshold range. The different eligible cloud computing resource unit options, such as different cloud instance configurations including different CPU and memory configuration options, are evaluated to determine whether an option more closely fits the user configurable resource evaluation criteria than the current configuration. In some embodiments, a selected one of the eligible cloud computing resource unit options is indicated as the better match than the current cloud computing resource unit handling the cloud computing instance. Based on the evaluation of different eligible cloud computing resource unit options, a recommended option is selected that is more optimal than the current configuration. As an example, the current configuration may be CPU and memory bound but under-utilizes storage. A new option that is more optimal can include a CPU configuration with more cores, less storage, and more memory. Depending on the configuration, benefits to selecting a new configuration can be monetary and/or performance based. In various embodiments, a migration path is presented to the administrator that includes scheduling the automatic migration to a new configuration option. For example, an administrator is presented via an online management client with different automatically identified cloud instance configurations that are more optimal. Once a configuration is selected, the administrator can schedule the migration from the old cloud instance to a new cloud instance using the newly selected configuration. In some embodiments, a failover and/or rollback options are prepared as part of the migration event.

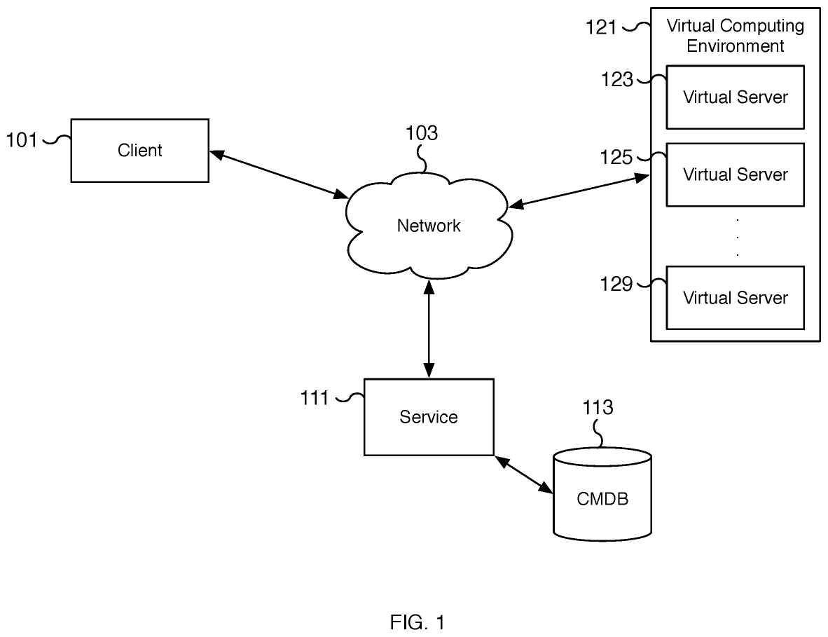

FIG. 1 is a block diagram illustrating an example of a network environment for running and configuring cloud instances. In the example shown, client 101 is a network client used to access service 111 for administering cloud instances that are part of virtual computing environment 121. Virtual computing environment 121 includes multiple cloud instances such as virtual servers 123, 125, and 129. Client 101 manages the cloud instances of virtual computing environment 121 by interfacing with service 111 and configuration management database (CMDB) 113. Client 101, service 111, and virtual computing environment 121 are communicatively connected via network 103. Network 103 can be a public or private network. For example, virtual servers 123, 125, and 129 of virtual computing environment 121 can be virtual servers hosted on a private network. In some embodiments, network 103 is a public network such as the Internet.

In some embodiments, client 101 may include a web browser that is utilized by a network administrator to access service 111. Service 111 is a network-accessible service such as a web service that provides a user interface for client 101 and its administrator to manage assets. In some embodiments, service 111 is a software service such as a software as a service (SAAS) application. Service 111 utilizes CMDB 113 to store and retrieve information related to managed assets, including cloud instances such as virtual servers 123, 125, and 129. In various embodiments, CMDB 113 is a configuration management database used for managing assets that are under the management of an organization. Each managed asset can be represented as a configuration item. CMDB 113 stores information related to managed assets, such as the hardware and/or software configuration of a cloud instance, as configuration items. In various embodiments, CMDB 113 provides persistent storage and allows an administrator via client 101 to remotely manage assets tracked using CMDB 113.

In some embodiments, service 111 includes additional functionality such as the ability to automatically reconfigure cloud instances. In the example shown, virtual computing environment 121 includes multiple virtual servers including virtual servers 123, 125, and 129. Each virtual server, such as virtual servers 123, 125, and 129, can be utilized as a cloud instance and has a corresponding hardware and software configuration. For example, a software configuration can include the type of operating system as well as the particular configuration of the operating system. Software configurations can include installed drivers and/or software packages, among other configurable options. Hardware configurations can include CPU, GPU, memory, network, and disk configurations, among others. In some embodiments, virtual servers 123, 125, and/or 129 are dedicated private servers and each server does not share hardware or software resources.

In some embodiments, service 111 manages cloud instances and keeps track of the particular configuration of each managed instance. Measurements of the utilization of a managed cloud instance are captured over time. For example, CPU, GPU, memory, inbound and/or outbound network, and/or storage utilization is tracked over time. In some embodiments, one or more monitoring agents are utilized to capture the utilization over time. For example, an agent running on a virtual server can capture memory usage. As another example, a network agent running on or communicatively attached to a virtual server can capture inbound and/or outbound network usage. Using a lookback duration, such as a configuration time window, the measurements are analyzed and compared to target or ideal operating requirements. In some embodiments, the ideal operating requirements are configured using user configurable resource evaluation criteria. For example, an administrator can specify an ideal CPU utilization range. As another example, an administrator can specify an ideal range for GPU utilization, memory usage, inbound network usage, outbound network usage, and/or disk access. In some embodiments, evaluation criteria are specified separately for peak, average, and/or idle measurements. Metrics based on the utilization measurements captured for a cloud instance are calculated and compared to the ideal operating requirements. For example, the CPU of a cloud instance can be over-utilized or under-utilized. Metrics for CPU utilization are compared to user configurable CPU evaluation criteria. In the event metrics for CPU utilization are below a specified evaluation threshold, the CPU is under-utilized. Similarly, in the event metrics for CPU utilization are above a specified evaluation threshold, the CPU is over-utilized.

In some embodiments, service 111 utilizes an up to date list of eligible cloud computing resource unit options. For example, a query for eligible cloud computing resource unit options is performed to determine what cloud instance configuration options are available. Different available configurations can provide different hardware configurations such as different CPU, GPU, memory, disk, and/or network configurations, among others, as well as different software configurations. The available options are used to determine whether a compatible option is better suited for the current deployment scenario. For example, a CPU configuration with a faster processor and/or more cores may be better suited for a deployment where the CPU utilization of the current cloud instance is over-utilized. As another example, a CPU configuration with a slower processor and/or fewer cores may be better suited for a deployment where the CPU utilization of the current cloud instance is under-utilized. The difference in configuration can also correspond to a change in pricing. In some embodiments, the configuration optimization takes into account the pricing difference between different cloud computing resource units. For example, in addition to performance, pricing is another variable the cloud configuration can be optimized for. In various embodiments, a more optimal configuration is determined and service 111 provides the selected configuration to an administrator via client 101. Using client 101, an administrator can configure the automatic migration from the current cloud instance(s) to one or more new cloud instances that utilize a new cloud computing resource unit. In various embodiments, the migration can include setting up a failover and/or rollback option. For example, in the event the migration does not perform as intended, a rollback operation can be initiated to revert the deployment from using the new cloud computing resource unit back to the current cloud computing resource unit.

In some embodiments, the workload on cloud instances, such as virtual servers 123, 125, and 129, is dynamic and complex. The performance and demand on a cloud instance can change rapidly. Performance requirements can change depending on user demand, seasonality, and factors outside of an administrator's control, particularly for public deployments. For example, typically there are portions of a public network infrastructure that are outside of a cloud instance administrator's control. The configuration of cloud instances and their computing resource units is a technically complex and difficult task and cloud instances can frequently operate outside of ideal operating ranges. By utilizing service 111 and CMDB 113 via client 101, an administrator can manage cloud instance configurations and automatically reconfigure any instance based on target or ideal operating requirements.

In various embodiments, the components shown in FIG. 1 may exist in various combinations of hardware machines. Although single instances of components have been shown to simplify the diagram, additional instances of any of the components shown in FIG. 1 may exist. For example, service 111 may include one or more servers. Similarly, CMDB 113 may not be directly connected to service 111 and/or may be replicated or distributed across multiple components. As another example, virtual servers can be deployed across multiple different virtual computing environments. In some embodiments, components not shown in FIG. 1 may also exist.

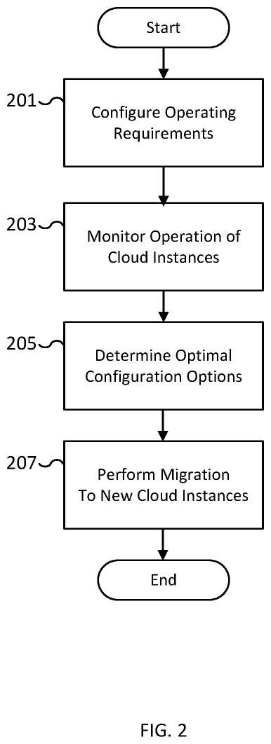

FIG. 2 is a flow chart illustrating an embodiment of a process for optimizing the configuration of cloud instances. Utilizing the process of FIG. 2, a more optimal cloud instance configuration is determined for the deployment of services on a virtual server. In some embodiments, the new configuration involves utilizing a cloud instance with a different cloud computing resource unit, such as a different hardware and/or software configuration. In various embodiments, the eligible options are changed over time and new options are continuously evaluated to determine a better match. When a better match is identified, a deployment can be transitioned from the current cloud instance to a more efficient cloud instance. In some embodiments, the efficiencies are measured by performance and/or cost. In some embodiments, the process of FIG. 2 is performed by a software service such as service 111 of FIG. 1 using an interactive client such as client 101 of FIG. 1. In some embodiments, the cloud instances being optimized are the virtual servers of a virtual computing environment such as virtual servers 123, 125, and/or 129 of virtual computing environment 121 of FIG. 1. In some embodiments, the cloud instances are managed using a configuration management database (CMDB) such as CMDB 113 of FIG. 1.

At 201, operating requirements are configured. For example, ideal or target operating requirements are configured. In some embodiments, the requirements are user configurable resource evaluation criteria. For example, an administrator can specify an operating threshold, such as an ideal or target operating range for different operating parameters. Operating parameters can include hardware performance operating parameters, such as CPU, GPU, memory, disk, and/or network performance operating parameters, among others. In some embodiments, the operating parameters include software parameters related to software performance. Example software performance parameters can include response times to web requests and/or database queries. In various embodiments, configurable resource evaluation criteria can include hardware and/or software requirements. For example, software requirements may include the installation and availability of one or more software drivers and/or software packages. As another example, a software requirement may include the installation of a particular operating system or operating system configurations such as support for a particular file system format. In various embodiments, hardware requirements can include any number of hardware requirements such as requirements related to GPU support, memory types, network interfaces, and/or security hardware, among others. In some embodiments, the operating requirements are stored for later retrieval from a configuration management database (CMDB) such as CMDB 113 of FIG. 1.

At 203, the operation of cloud instances is monitored. For example, a virtual server is monitored for its performance. In some embodiments, the performance is monitored by an agent running alongside deployed software on the virtual server. An agent can also be hosted remote from the cloud instance. The performance of each cloud instance is monitored over time to gather sufficient data for evaluating the configuration of each cloud instance. In various embodiments, the performance measurements gathered can include CPU, GPU, memory, disk, and/or network performance measurements, among others. For example, inbound and outbound network performance can be monitored separately. As another example, memory read and/or write performance as well as memory usage can be monitored. In various embodiments, measurements are gathered to determine peak as well as average and idle performance. In some embodiments, the granularity of the monitoring is configurable. For example, measurements can be gathered based on a time granularity such as every 5 minutes, every 15 minutes, every hour, or based on another appropriate time frame.

At 205, optimal configuration options are determined. Based on the requirements specified at 201 and the data gathered by monitoring at 203, one or more optimal configuration operations are determined. In various embodiments, an initial set of available options is first determined. For example, one or more different cloud providers are queried for their available configuration options. Examples include different CPU, memory, network, and disk configurations. In various embodiments, the different configurations are different cloud computing resource units. One cloud computing resource unit may utilize a particular processor type, for example, having a particular processor speed and number of cores, a particular amount of disk storage, such as a particular amount of SSD storage, a particular amount of memory, such as a particular amount of RAM, and a particular network configuration, such as a particular inbound and outbound network speed and corresponding available bandwidth. In various embodiments, pricing information is associated with each configuration and/or cloud computing resource unit. In some embodiments, the configurations include software configuration options such as the availability of different software drivers, software packages, and operating systems. For example, a software configuration can include the availability of a particular software package such as a particular database, machine learning, and/or imaging package, among others.

In various embodiments, once eligible cloud computing options are determined, for example, by querying one or more different cloud computing catalogs, a more optimal cloud instance configuration is identified, if available. For example, an eligible cloud computing resource unit option can provide a more optimal computing experience based on the requirements specified at 201. In some embodiments, to determine if an option is better, the operating data gathered at 203 is compared to the requirements configured at 201. In various embodiments, metrics are calculated based on measurements gathered at 203. For example, CPU performance measurements can be normalized so that different CPU types can be compared. As one example, in the event the CPU of a cloud instance is over-utilized, a determination can be made that a more powerful CPU is needed to meet operating requirements. Based on the eligible options, an eligible CPU configuration is identified. The CPU configuration may include a faster processor and/or a CPU with more operating cores. Similarly, different operating requirements can be applied to different hardware and/or software components, such as to memory, disk, and network requirements, among others, to determine optional virtual server configuration options.

At 207, migration to new cloud instances is performed. For example, an administrator is provided with a more optimal cloud instance configuration. Once a more optimal configuration is selected and/or approved, the administrator can schedule the automatic migration from the current configuration to the newly selected configuration. In various embodiments, new cloud instances utilizing a new configuration and a different cloud computing resource unit are activated and the current cloud instances are deactivated. In some embodiments, failover and/or rollback options are also configured. A configuration management database (CMDB) such as CMDB 113 of FIG. 1 can be updated to keep track of the migration event and related configuration changes.

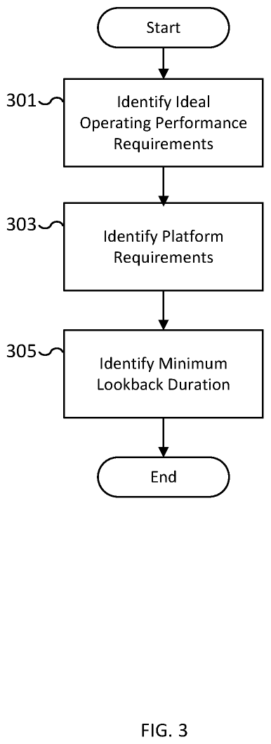

FIG. 3 is a flow chart illustrating an embodiment of a process for configuring operating requirements of cloud instances. Utilizing the process of FIG. 2, an administrator can specify operating requirements such as performance targets for a cloud instance. For example, an administrator can specify ideal operating performance parameters such as hardware and/or software components. An administrator can also specify hardware and software requirements such as particular hardware and software features that must be supported by an eligible cloud instance and cloud computing resource unit. In some embodiments, the process of FIG. 3 is performed at 201 of FIG. 2. In some embodiments, the information related to cloud instance configuration is stored for retrieval in a configuration management database (CMDB) such as CMDB 113 of FIG. 1.

At 301, ideal operating performance requirements are identified. For example, ideal operating requirements related to the operating performance of hardware and/or software components are identified. In some embodiments, the identified requirements are received from an administrator via a client interface such as client 101 of FIG. 1. The received requirements can be stored in a configuration management database (CMDB) such as CMDB 113 of FIG. 1 and are retrieved from the CMDB when needed. Information related to the current cloud instance including information on the current cloud computing resource unit can be retrieved from the CMDB as part of identifying ideal operating performance requirements. The ideal requirements can be specified as a threshold range, such as a minimum and a maximum value pair. For example, a CPU operating requirement can be specified as an ideal operating utilization threshold range. A CPU utilization above the high end of the threshold range indicates over-utilization and a CPU utilization below the low end of the threshold range indicates under-utilization. Similarly, a memory operating requirement can be specified as an ideal memory utilization threshold. In some embodiments, the requirements specify multiple ideal requirements for a component, such as a peak performance requirement and an average performance requirement. The granularity related to requirements can be identified as well. For example, the performance can be measured based on a time granularity such as every 5 minutes, every 15 minutes, every hour, or based on another appropriate time frame. A granularity of 5 minutes can indicate that the performance for a particular component is identified for that component over a 5 minute time period.

At 303, platform requirements are identified. For example, requirements such as hardware and/or software requirements are identified. Hardware requirements can include requirements such as requiring a particular GPU feature, RAM type, and/or storage medium type, among others. Software requirements can include requiring a particular software driver, operating system, operating system configuration, and/or software package, among others. A compatible cloud computing instance must meet the identified platform requirements. In some embodiments, the requirements are based on the capabilities of the cloud computing resource unit. In various embodiments, the platform requirements are received from an administrator via a client interface such as client 101 of FIG. 1. In some embodiments, the platform requirements are stored in a configuration management database (CMDB) such as CMDB 113 of FIG. 1 and are retrieved from the CMDB when needed.

At 305, a minimum lookback duration is identified. For example, a minimum time window over which the performance of a cloud instance is analyzed is identified. In some embodiments, measurements of a cloud instance must span the minimum lookback duration before being considered valid. Examples of a minimum lookback duration include 4 hours, 3 days, a week, 10 days, 2 weeks, or another appropriate time window. In some embodiments, the minimum lookback duration is received from an administrator via a client interface such as client 101 of FIG. 1 and may be stored in a configuration management database (CMDB) such as CMDB 113 of FIG. 1.

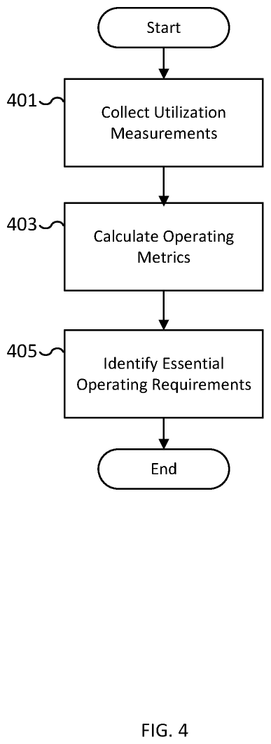

FIG. 4 is a flow chart illustrating an embodiment of a process for monitoring the operation of a cloud instance. Utilizing the process of FIG. 4, the performance of a virtual server can be compared to a specified target or ideal operating requirements to determine a more optimal configuration. In some embodiments, the monitoring is performed remotely, for example, by querying a cloud instance. The monitoring can also be performed at least in part by running a monitoring agent on the cloud instance. For example, some components are more accurately measured by running an agent local to a virtual server and then remotely retrieving the captured measurements. In some embodiments, the process of FIG. 4 is performed at 203 of FIG. 2. In some embodiments, the information related to the operation of a cloud instance is stored for retrieval in a configuration management database (CMDB) such as CMDB 113 of FIG. 1.

At 401, utilization measurements are collected. For example, measurements corresponding to different operating requirements are collected. Measurements can be collected for different hardware components, software components, and/or hardware or software functionality. Examples of measurements include CPU utilization, GPU utilization, memory utilization, memory access times, storage (or disk) utilization, storage access times, power consumption, operating temperature, fan speed, fan operation, air flow, network performance, and network utilization, among others. Other appropriate utilization and performance measurements can be collected as well. In various embodiments, the measurements are stored in a database such as CMDB 113 of FIG. 1.

At 403, operating metrics are calculated. For example, metrics for a cloud instance are calculated using the measurements collected at 401. In some embodiments, the metrics are calculated only after a minimum time duration such as a minimum lookback duration has passed. For example, in the event the minimum lookback duration is configured for 14 days, measurements are collected at 401 for at least 14 days before metrics are calculated using the corresponding measurements. In various embodiments, the metrics are calculated by normalizing the operating data. For example, performance measurements are normalized to allow the collected measurements to be compared or evaluated for different hardware configurations. As one example, different CPU processors can have vastly different processing speeds, core counts, and possibly different instruction sets. Normalizing the processor utilization measurements allows the different CPU configurations to be compared with one another. Similarly, GPU measurements can be normalized to compare different GPU configurations. In some embodiments, the metrics are calculated using a configured granularity. For example, in the event a time granularity is configured to a configuration such as 5 minutes, metrics are calculated for every 5 minutes over the minimum lookback duration.

In some embodiments, multiple metrics, such as peak, average, and idle metrics, among others, are calculated for each measurement. For example, a peak CPU utilization can be calculated by averaging the top 20% of captured CPU utilization measurements. In some embodiments, a different formulation for determining peak CPU utilization is utilized as appropriate. For example, the peak CPU utilization can use a different cutoff than 20%. In various embodiments, the metrics calculated are based on the identified operating requirements and/or user configurable resource evaluation criteria. The calculated metrics can be later used to determine whether a more optimal cloud computing resource unit is available.

At 405, essential operating requirements are identified. In some embodiments, one or more additional essential operating requirements are identified by monitoring the operation of a cloud instance. The identified requirements can supplement the platform requirements identified at 303 by monitoring the runtime operation of a virtual server. For example, an analysis of the software deployed on a virtual server during runtime identifies software and/or hardware components that are run or utilized over a particular duration of the virtual server's operation. The identified software and/or hardware components are used to generate a list of platform requirements. The identified requirements can be used at a later stage to identify compatible cloud computing resource units. In some embodiments, step 405 is an optional step.

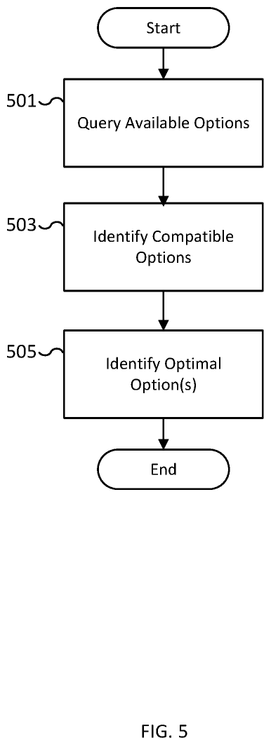

FIG. 5 is a flow chart illustrating an embodiment of a process for identifying optimal cloud instance configurations. Utilizing the process of FIG. 5, a current cloud instance configuration is evaluated to determine whether there are additional cloud instance configurations using different cloud computing resource units that are both available and compatible for the current deployment scenario. In some embodiments, a better match is identified which can provide not only performance improvements but also significant monetary savings. In various embodiments, a more optimal configuration can involve sizing up or sizing down one or more components. For example, a CPU component can be sized up to provide additional processing (or compute) power if the CPU is over-utilized while an SSD storage component can be sized down to provide less storage in the event storage is under-utilized. In some embodiments, the process of FIG. 5 is performed at 205 of FIG. 2. In some embodiments, the information related to a current cloud instance and its cloud computing resource unit is stored for retrieval in a configuration management database (CMDB) such as CMDB 113 of FIG. 1.

At 501, available options are queried. For example, one or more cloud providers are queried for a current catalog of cloud offerings. In some embodiments, the cloud instance offerings are sorted by different cloud computing resource units. For example, each different cloud computing resource unit can correspond to a different virtual server configuration. The different hardware and software server configurations are associated with each cloud computing resource unit option to determine, at a later step, whether a more optimal cloud instance configuration exists. In some embodiments, the queried results include pricing information for each option. In various embodiments, the available options may be stored in and/or tracked using a configuration management database (CMDB) such as CMDB 113 of FIG. 1.

At 503, compatible options are identified. Using the available options from the query at 501, compatible cloud instance options are identified. Only cloud instances that meet all the operating requirements are considered valid options. In some embodiments, the requirements are identified at least in part from input by an administrator. In some embodiments, the requirements are identified at 301 of FIG. 3 and/or at 405 of FIG. 4. Using the requirements, the available cloud offers are culled to only include compatible options. In some embodiments, the options are identified by configuration such as by a particular cloud computing resource unit. From the identified compatible options, some options may be more optimal than, less optimal than, or similar in performance to the current cloud instance.

In some embodiments, the compatible options are identified by applying the operating measurements collected and/or metrics calculated for a current cloud instance to determine the compatible options from all available cloud instance options. As an example scenario, the peak memory utilization is calculated and a determination is made that the memory component of a cloud instance is over-utilized according to user configurable resource evaluation criteria. The measurements collected corresponding to the peak memory usage can be used to identify options that are compatible based on an option having the appropriate memory configuration size. For example, any configuration where RAM memory is less than the peak memory usage is discarded as not compatible. In some embodiments, a buffer room amount of memory is added to the peak measurement and only configurations with memory that is at least as large as the peak memory usage plus a buffer room amount are compatible. Similarly, in another example scenario, network inbound (or outbound) utilization metrics determine that the network interface is over-utilized. Any configuration where the network configuration supports less than the peak network usage is discarded as not compatible.

At 505, more optimal options are identified. Using user configurable resource evaluation criteria, more optimal cloud instance configurations are identified from the compatible options. A cloud instance is more optimal than a current configuration if the cloud instance operates according to user configurable resource evaluation criteria. In some embodiments, information related to a current cloud instance and its cloud computing resource unit is retrieved from a configuration management database (CMDB) such as CMDB 113 of FIG. 1. In the event more than one cloud instance configuration meets the user configurable resource evaluation criteria (including the current configuration), the cost requirement of each configuration can be a factor as well. For example, the least expensive configuration can be identified as the most optimal configuration when multiple configurations meet the user configurable resource evaluation criteria. In some embodiments, a minimum threshold for savings is configured by an administrator. A cloud instance option must meet the minimum savings threshold in order to be consider more optimal. For example, in the event the savings of a new option do not meet a minimum threshold value, the new configuration option is not considered more optimal than the current configuration. In various embodiments, the identified options that are more optimal than the current configuration are provided as an option for migration. By selecting a more optimal configuration, operating costs and/or the operating performance for deploying to a cloud instance can be significantly improved.

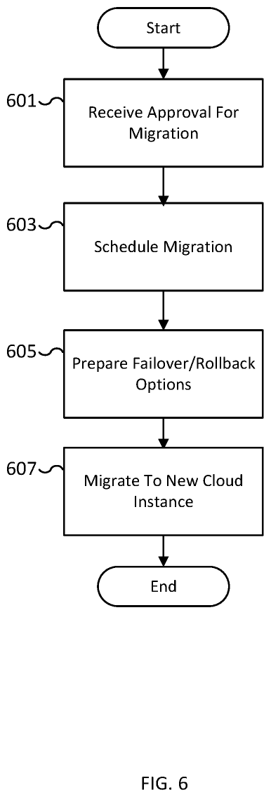

FIG. 6 is a flow chart illustrating an embodiment of a process for migrating to a new cloud instance configuration. Utilizing the process of FIG. 6, a deployment is transitioned from the current cloud instance configuration to a more optimal cloud instance configuration. The new cloud instance uses a different cloud computing resource unit corresponding to a different hardware and/or software configuration. The new configuration can also be associated with a different cost. In various embodiments, a more optimal cloud instance configuration is determined using the processes described above including the processes of FIGS. 2-5. The new configuration utilizes a cloud computing resource unit that is a better match than the current cloud computing resource unit. In some embodiments, the new configuration has the benefit of being significantly less expensive while meeting all existing performance requirements. The current cloud instance may be migrated to multiple new cloud instances, each using a newly selected cloud computing resource unit. In some embodiments, the process of FIG. 6 is performed at 207 of FIG. 2.

At 601, approval for migration is received. For example, an administrator approves the migration from a current cloud instance to a new cloud instance using a different cloud computing resource unit (or cloud instance configuration). In various embodiments, the user is presented with the more optimal new configuration via an interactive client such as client 101 of FIG. 1. In some embodiments, the cost associated with the new configuration is presented to the user including any projected cost savings from migration to the new cloud instance. In various embodiments, multiple configurations exist that are more optimal than the current cloud instance and one of the configuration options is suggested as the best match for the intended deployment.

At 603, migration is scheduled. Using the approved configuration, a migration from the current cloud instance to the selected configuration is scheduled. In some embodiments, the scheduling is automated. For example, a default timeframe is configured for provisioning the new cloud instance, redirecting requests from the old cloud instance to the new cloud instance, and disabling the old cloud instance. The timeframe of the migration may be based on the utilization of the cloud instance. For example, the migration may be schedule for a time when the cloud instance is relatively idle. In some embodiments, relevant data and/or settings are transferred in advance from the old cloud instance to the new cloud instance. In various embodiments, an administrator can modify default configuration such as the timing of the migration.

At 605, failover and/or rollback options are prepared. For example, backup options are prepared in the event the migration experiences a failure or the deployed cloud instance expects a failure to occur. As one example, a rollback option can be prepared. A rollback option allows a new cloud instance to be rolled back to a cloud instance with the same configuration as the previously provisioned (and current) cloud instance. In some embodiments, the same virtual server or cloud instance is utilized. In various embodiments, a rollback option allows the deployment to be reverted to the current configuration used prior to migration.

In some embodiments, a failover option is prepared that can be different from the rollback option. For example, a failover option can utilize a configuration such as a cloud computing resource unit that is different from both the new and current configurations. For example, in the event the current configuration is CPU bound and the selected migration option increases CPU compute performance, a failover option can be selected that also increases CPU compute performance but by an even greater amount. In the event the selected option is found to fail (or enter a failure or pre-failure state) because of CPU over-utilization, the failover option with increased CPU compute performance can be utilized. In various embodiments, the failover option is one of the eligible migration options but at the time of selecting the new configuration option for migration, the failover option is not the most optimal eligible option. For example, the failover option may offer more performance at a tradeoff such as greater cost, increased power consumption, less efficient utilization for other components, or another appropriate factor. In various embodiments, both the failover and/or rollback options can be optional.

In some embodiments, a failure in the new cloud computing instance can be detected and results in transitioning to the prepared rollback or failover option. The failed instance can be one of any number of errors (or detected potential errors) including issues related to under provisioning, a hardware or software failure, and/or an issue outside of the organization's control, such as an external routing error. In various embodiments, the transition to the prepared rollback or failover option allows the service to continue to operate with minimal downtime. Failures can be detected during the migration process and/or after the migration is complete and the new cloud instance is active.

At 607, migration to a new cloud instance is performed. Using the approved configuration at 601 and the scheduled migration planned at 603, a migration is performed and a new cloud instance utilizing a different configuration replaces an old cloud instance. In some embodiments, the migration includes transferring all relevant data and/or settings from the old cloud instance to the new cloud instance, provisioning the new cloud instance, redirecting requests from the old cloud instance to the new cloud instance, and disabling the old cloud instance. In various embodiments, once the new cloud instance is enabled, a series of validation checks are performed to ensure the new cloud instance meets all operating requirements. For example, a series of test queries can be directed to the new cloud instance to confirm the deployment is running correctly before migrating traffic from the old instance to the new instance. Although described with respect to a single old and a single new cloud instance, the migration can be performed with one or more old and new cloud instances. For example, multiple new cloud instances using a selected cloud computing resource unit can replace one or more older configurations.

In various embodiments, as part of the migration process, corresponding entries in a configuration management database (CMDB), such as CMDB 113 of FIG. 1, are updated to reflect the transition. The CMDB can keep track of the migration event and associate events related to the previous cloud instance with the new cloud instance. By utilizing the CMDB to optimize cloud configuration, significant events and usage information related to the previous cloud instance are not lost but instead can be transitioned and associated with the new cloud instance. Moreover, the use of a CMDB to optimize the configuration of cloud instances allows an administrator a better global view of the assets under management and to better understand and evaluate the benefits of the cloud instance optimization.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving cloud computing utilization measurements associated with a cloud computing instance;
calculating metrics based on the cloud computing utilization measurements;
evaluating based on a user configurable resource evaluation criteria whether a different cloud computing resource unit among eligible cloud computing resource unit options is a better match than a current cloud computing resource unit handling the cloud computing instance; and
indicating a selected one of the eligible cloud computing resource unit options as the better match than the current cloud computing resource unit handling the cloud computing instance.

2. The method of claim 1, wherein at least a portion of the user configurable resource evaluation criteria is based on a lookback duration.

3. The method of claim 1, wherein the user configurable resource evaluation criteria includes one or more utilization metrics of the cloud computing instance.

4. The method of claim 3, wherein a utilization metric of the one or more utilization metrics of the cloud computing instance specifies a peak, average, or idle metric.

5. The method of claim 3, wherein a utilization metric of the one or more utilization metrics of the cloud computing instance specifies a threshold range.

6. The method of claim 5, wherein the threshold range is a CPU utilization range.

7. The method of claim 3, wherein the one or more utilization metrics of the cloud computing instance includes a CPU usage, a memory usage, a disk usage, or a network usage utilization metric.

8. The method of claim 7, wherein the network usage utilization metric includes an inbound metric and a separate outbound metric.

9. The method of claim 1, wherein the user configurable resource evaluation criteria includes one or more hardware or software requirements.

10. The method of claim 9, wherein the one or more software requirements includes a software driver or operating system requirement.

11. The method of claim 1, further comprising retrieving information of the cloud computing instance and the current cloud computing resource unit handling the cloud computing instance from a configuration management database (CMDB).

12. The method of claim 1, further comprising scheduling a migration from the current cloud computing resource unit handling the cloud computing instance to the selected one of the eligible cloud computing resource unit options.

13. The method of claim 12, further comprising preparing a rollback option configured to utilize the current cloud computing resource unit handling the cloud computing instance.

14. The method of claim 13, further comprising:
migrating from the cloud computing instance to the different cloud computing instance;
detecting a failure in the different cloud computing instance; and
transitioning to the prepared rollback option from the failed different cloud computing instance.

15. The method of claim 1, wherein calculating metrics based on the cloud computing utilization measurements includes normalizing CPU measurements.

16. The method of claim 1, wherein one or more of the received cloud computing utilization measurements associated with the cloud computing instance are captured by an agent monitoring the cloud computing instance.

17. The method of claim 1, further comprising calculating a monetary difference amount between utilizing the selected one of the eligible cloud computing resource unit options as compared to the current cloud computing resource unit handling the cloud computing instance.

18. The method of claim 17, further comprising providing the calculated monetary difference amount to a cloud instance configuration service.

19. A system, comprising:
one or more processors configured to:
receive cloud computing utilization measurements associated with a cloud computing instance;
calculate metrics based on the cloud computing utilization measurements;
evaluate based on a user configurable resource evaluation criteria whether a different cloud computing resource unit among eligible cloud computing resource unit options is a better match than a current cloud computing resource unit handling the cloud computing instance; and
indicate a selected one of the eligible cloud computing resource unit options as the better match than the current cloud computing resource unit handling the cloud computing instance; and
a memory coupled to at least one of the one or more processors and configured to provide the at least one of the one or more processors with instructions.

20. A computer program product, the computer program product being embodied in a non-transitory computer readable storage medium and comprising computer instructions for:
receiving cloud computing utilization measurements associated with a cloud computing instance;
calculating metrics based on the cloud computing utilization measurements;
evaluating based on a user configurable resource evaluation criteria whether a different cloud computing resource unit among eligible cloud computing resource unit options is a better match than a current cloud computing resource unit handling the cloud computing instance; and
indicating a selected one of the eligible cloud computing resource unit options as the better match than the current cloud computing resource unit handling the cloud computing instance.
